(19) United States
(12) Patent Application Publication
(10) Pub. No.: US 2011/0198824 A1
(43) Pub. Date: Aug. 18, 2011

(54) Utility trailer

(75) Inventor: Vladan Markovich, Aurora (CA)

(73) Assignee: SNOWBEAR LIMITED

(21) Appl. No.: 12/656,883

(22) Filed: Feb. 18, 2010

(51) Int. Cl. B62D 63/06

(52) U.S. Cl. 280/400

(57) ABSTRACT

The present invention relates to the field of utility trailers, in particular, utility trailers with rear pivotable gates. The utility trailer includes a trailer bed supported on wheels for rolling motion on the ground. The trailer bed has a floor on which cargo may be placed and a support frame for carrying the floor. The support frame includes a front end; a rear end; and a pair of spaced apart, upper and lower, bent U-shaped members extending between the front and rear ends of the support frame. Each U-shaped member is fabricated from a hollow section having one of a square cross-section and a rectangular cross-section. The support frame further includes a plurality of spaced apart, substantially upright struts extending between, and connecting the upper and lower bent U-shaped members to each other and a plurality of spaced apart cross-members connecting portions of the lower bent U-shaped member to each other. The utility trailer is also provided with a gate pivotally mounted to rear end of the support frame. The gate is movable between a substantially upright position relative to the floor of the trailer bed and a lowered, in-use position.

### FIELD OF THE INVENTION

The present invention relates to the field of utility trailers, in particular, utility trailers with rear pivotable gates.

### BACKGROUND OF THE INVENTION

Conventional utility trailers with pivotable rear gates often have generally C-shaped or U-shaped support frames (when viewed in top plan). Such support frames are usually built up of several structural members in the nature of longitudinal side members and cross-members and have welded joints at the corners where the longitudinal side members meet the front cross-member. The assembly of such frames can be labour-intensive and may require extensive welding. Moreover, from a structural design perspective, the formation of welded joints at the corners of the support frame tends not to be desirable, as the corners tend to be subjected to significant bending moments and shear stresses, often resulting in the failure of these welded joints. When such frames are fabricated from tubular hollow sections having circular profiles, these problems may be further exacerbated by the fact that welding arcuate surfaces tends to be more complicated and tends to require the implementation of special measures (for instance, the formation of arcuate notches—corresponding to curvature in the hollow sections—at the ends of some of the hollow sections where the welding connection is to be made), so as to ensure the weld is properly formed.

In light of the foregoing, there is a real need for a utility trailer exhibiting improved resistance to bending moments and shear stresses at the corners of the support frame. Preferably, such a utility trailer would be lightweight, robust and less prone to structural failures in its support frame. It would be further desirable, if the manufacturing of such a utility trailer could be simplified by reducing the welding required.

### SUMMARY OF THE INVENTION

According to a broad aspect of an embodiment of the present invention, there is provided a utility trailer. The utility trailer includes a trailer bed supported on wheels for rolling motion on the ground. The trailer bed has a floor on which cargo may be placed and a support frame for carrying the floor. The support frame includes a front end; a rear end; and a pair of spaced apart, upper and lower, bent U-shaped members extending between the front and rear ends of the support frame. Each U-shaped member is fabricated from a hollow section having one of a square cross-section and a rectangular cross-section. The support frame further includes a plurality of spaced apart, substantially upright struts extending between, and connecting the upper and lower bent U-shaped members to each other and a plurality of spaced apart cross-members connecting portions of the lower bent U-shaped member to each other. The utility trailer is also provided with a gate pivotally mounted to rear end of the support frame. The gate is movable between a substantially upright position relative to the floor of the trailer bed and a lowered, in-use position.

In a further feature, the floor is supported on the lower bent U-shaped member and the plurality of cross-members.

In another feature, at least one of the upper and lower bent U-shaped members has a square cross-section. In an additional feature, both the upper and lower bent U-shaped members have a square cross-section. Alternatively, at least one of the bent U-shaped members has a rectangular cross-section or both the upper and lower bent U-shaped members could have a rectangular cross-section. In a further feature, the upper bent U-shaped member has a first cross-sectional area and the lower bent U-shaped member has a second cross-sectional area. The first cross-section area is smaller than or equal to the second cross-sectional area.

In yet another feature, each of the upper and lower bent U-shaped members includes a back portion and two opposed, generally parallel, first and second arm portions. The arm portions of each upper and lower bent U-shaped members are joined to the respective back portions of each upper and lower bent U-shaped members. Each of the upper and lower bent U-shaped members are formed with a first radiused corner portion whereat the back portion of each upper and lower bent U-shaped members transitions to become the respective first arm portion of each upper and lower bent U-shaped members, and a second radiused corner portion whereat the back portion of each upper and lower bent U-shaped members transitions to become the respective second arm portion of each upper and lower bent U-shaped members.

In still another feature, the portions connected by the plurality of cross-members are the first and second arm portions of the lower bent U-shaped member and the plurality of cross-members are disposed generally parallel to the back portion of the lower bent U-shaped member. Additionally, each arm portion of the lower bent U-shaped member has an inner lateral, planar face. The first end of each cross-member is welded to the inner face of the first arm portion and the second end of each cross-member is welded to the inner face of the second arm portion.

In a further feature, the first and second arm portions of the lower bent U-shaped member each include a proximal end connected to the back portion of the lower bent U-shaped member and a distal end. The plurality of cross-members includes first, second and third cross-members. The first cross-member is disposed adjacent the proximal ends of the first and second arm portions. The second cross-member is disposed adjacent the distal ends of the first and second arm portions and the third cross-member is disposed intermediate the first and second cross-members. In another feature, the plurality of cross-members have one of a square cross-section and a rectangular cross-section.

In yet another feature, the back portion and the first and second arm portions of the upper bent U-shaped member each have a lower planar face opposite the lower bent U-shaped member. The back portion and the first and second arm portions of the lower bent U-shaped member each have an upper planar face opposite the upper bent U-shaped member. Each strut of the plurality having an upper end and a lower end. The upper end of each strut is welded to the lower planar face of one the back portion and the first and second arm portions of the upper bent U-shaped member and the lower end of each strut is welded to the upper planar face of one the back portion and the first and second arm portions of the lower bent U-shaped member.

In still another feature, the plurality of upright struts includes a first series of struts joining the first arm portion of the upper bent U-shaped member to the first arm portion of the lower bent U-shaped member, a second series of struts joining the back portion of the upper bent U-shaped member to the back portion of the lower bent U-shaped member and a third series of struts joining the second arm portion of the upper bent U-shaped member to the second arm portion of the lower bent U-shaped member. In one feature, the first and second arm portions of each bent U-shaped member include a proximal end connected to the respective back portion of each bent U-shaped member and a distal end. The first series of struts includes first, second, third and fourth struts. The first strut is disposed adjacent the proximal ends of the first arm portions of the bent U-shaped members. The second strut is disposed adjacent the terminal ends of the first arm portions of the bent U-shaped members and the third and fourth struts are disposed intermediate the first and second struts.

In a further feature, the back portions of each bent U-shaped member include a first end joined to the respective first arm portion of each bent U-shaped member and a second end joined to the respective second arm portion of each bent U-shaped member. The second series of struts includes first, second and third struts. The first strut is disposed adjacent the first ends of the back portions of the bent U-shaped members. The second strut is disposed adjacent the second ends of the back portions of the bent U-shaped members and the third strut is disposed intermediate the first and second struts.

In yet another feature, the first and second arm portions of each bent U-shaped member include a proximal end connected to the respective back portion of each bent U-shaped member and a distal end. The third series of struts includes first, second, third and fourth struts. The first strut is disposed adjacent the proximal ends of the second arm portions of the bent U-shaped members. The second strut is disposed adjacent the terminal ends of the second arm portions of the bent U-shaped members and the third and fourth struts are disposed intermediate the first and second struts.

In additional feature, the plurality of struts have one of a square cross-section and a rectangular cross-section.

In still another feature, the utility trailer further includes at least one locking assembly engageable with the support frame and the gate for maintaining the gate in the substantially upright position.

### BRIEF DESCRIPTION OF THE DRAWINGS

The embodiments of the present invention shall be more clearly understood with reference to the following detailed description of the embodiments of the invention taken in conjunction with the accompanying drawings, in which:

FIG. 1 is a front right perspective view of an utility trailer in accordance with an embodiment of the invention;

FIG. 2 is a rear left perspective view of an utility trailer illustrated in FIG. 1 showing the gate in its raised position;

FIG. 3 is a side elevation view of the utility trailer shown in FIG. 1;

FIG. 4 is a top plan view of the utility trailer shown in FIG. 1;

FIG. 5 is a bottom plan view of the utility trailer shown in FIG. 1, with the floor panels removed for greater clarity;

FIG. 6 is an front perspective view of the frame of the utility trailer shown in FIG. 1, taken in isolation;

FIG. 7 is a top plan view of the frame shown in FIG. 6;

FIG. 8 is a cross-sectional view of the frame shown in FIG. 6 taken along line “8-8”;

FIG. 9 is an enlarged perspective view of the gate and locking mechanism shown in the encircled portion “9” in FIG. 2;

FIG. 10 is a rear left perspective view of the utility trailer similar to that illustrated in FIG. 2, but with the gate moved to its lowered declined (in-use) position; and

FIG. 11 is a rear left perspective view of the utility trailer similar to that illustrated in FIG. 2, but with the gate moved to its lowered (out-of-use) position.

### DETAILED DESCRIPTION OF EMBODIMENTS OF THE INVENTION

The description, which follows, and the embodiments described therein are provided by way of illustration of an example, or examples of particular embodiments of principles and aspects of the present invention. These examples are provided for the purposes of explanation and not of limitation, of those principles of the invention. In the description that follows, like parts are marked throughout the specification and the drawings with the same respective reference numerals.

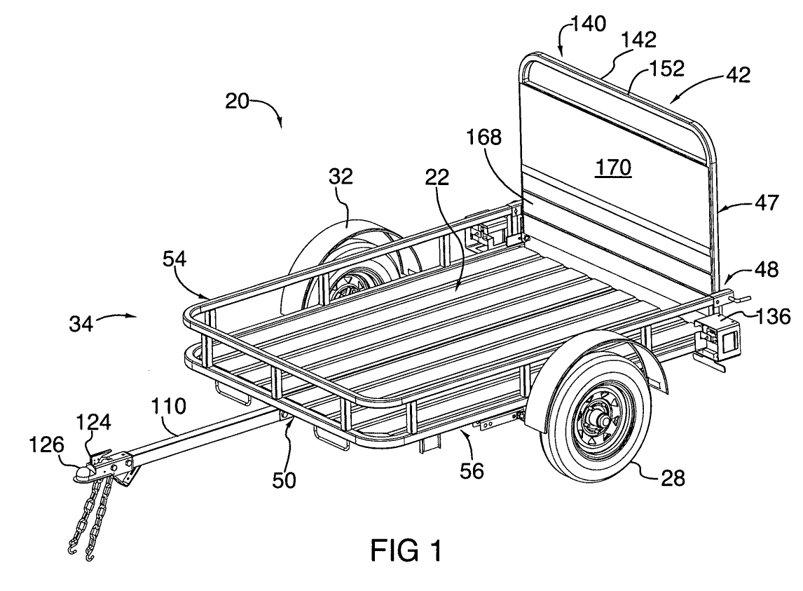

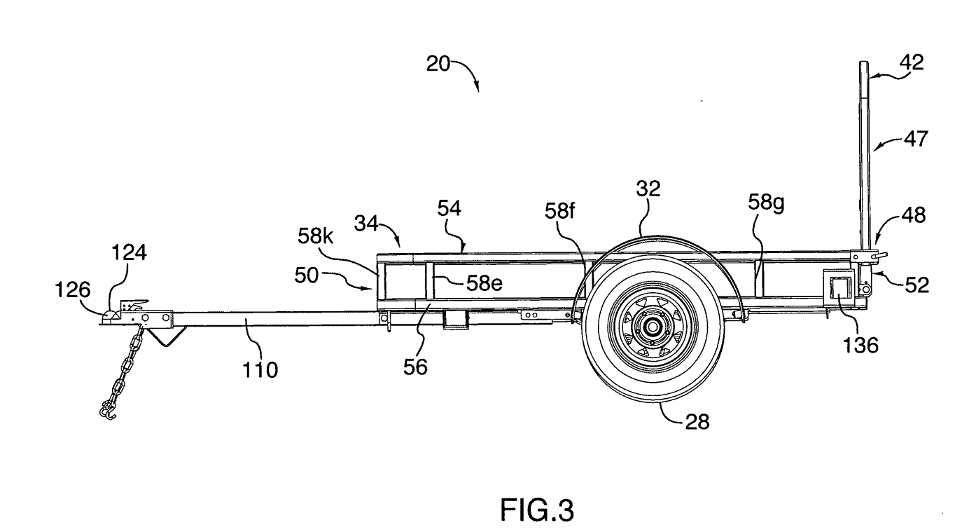

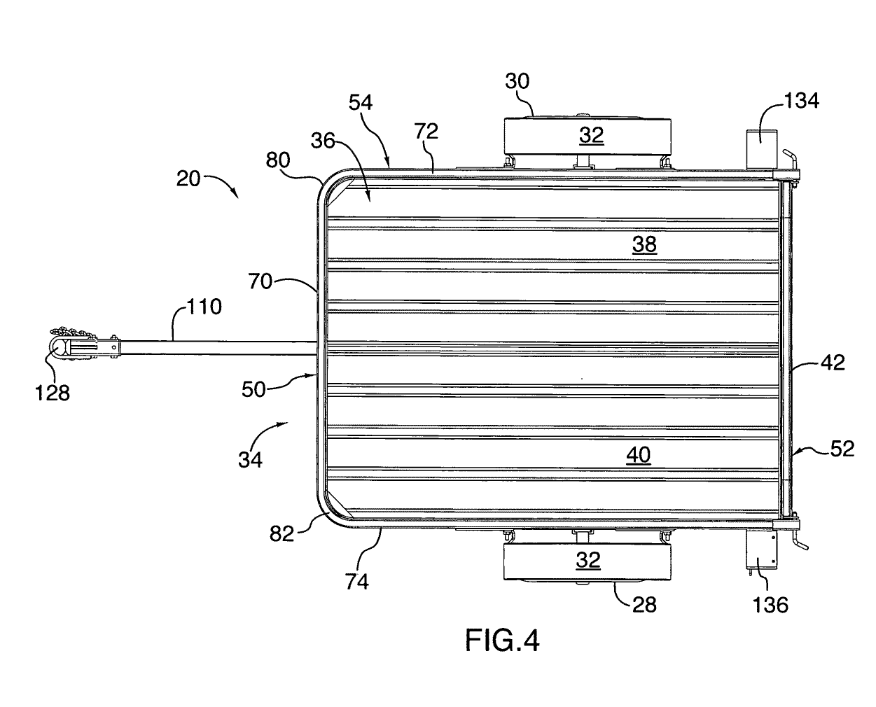

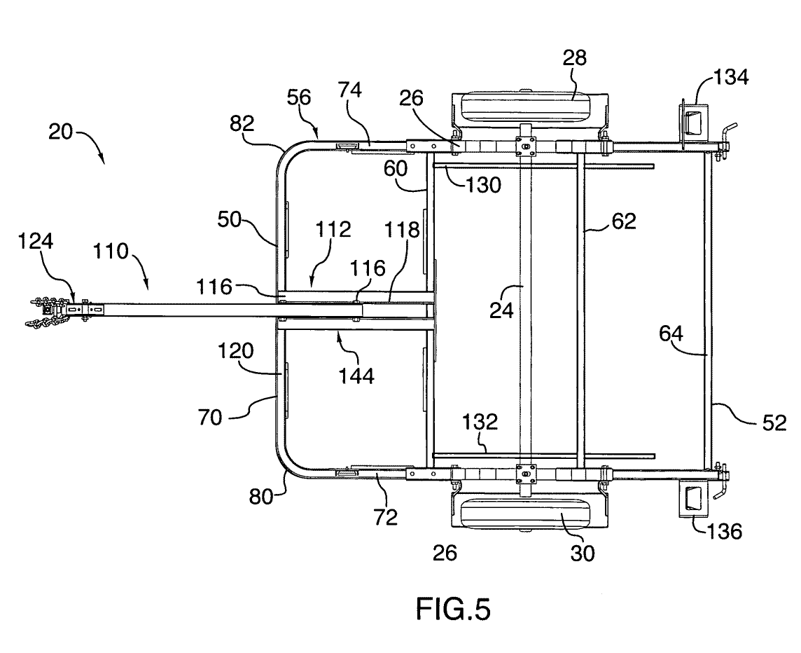

Referring to FIGS. 1 to 5, there is shown an utility trailer, designated generally with reference numeral 20. The trailer 20 is designed to be hitched to the rear of a motor vehicle (not shown) and towed. The trailer 20 has a trailer bed 22 which is supported on a single axle 24 via a multiple leaf spring-type suspension system 26 (visible in FIG. 5). The single axle 24 carries a pair of spaced apart wheels 28 and 30. Each wheel 28, 30 is provided with a protective wheel cover 32 that depends from the trailer bed 22. In an alternative embodiment, the trailer could be configured as a dual-axle trailer.

The trailer bed 22 is defined by a support frame 34 and a floor 36 mounted atop the support frame 34 upon which cargo may be placed. The floor 36 includes two floor panels 38 and 40 placed side-by-side and secured to the support frame 34. In the preferred embodiment, the floor panels 38 and 40 are solid panels of corrugated steel. In other embodiments, the floor may be fabricated of expanded steel mesh or any other suitable material.

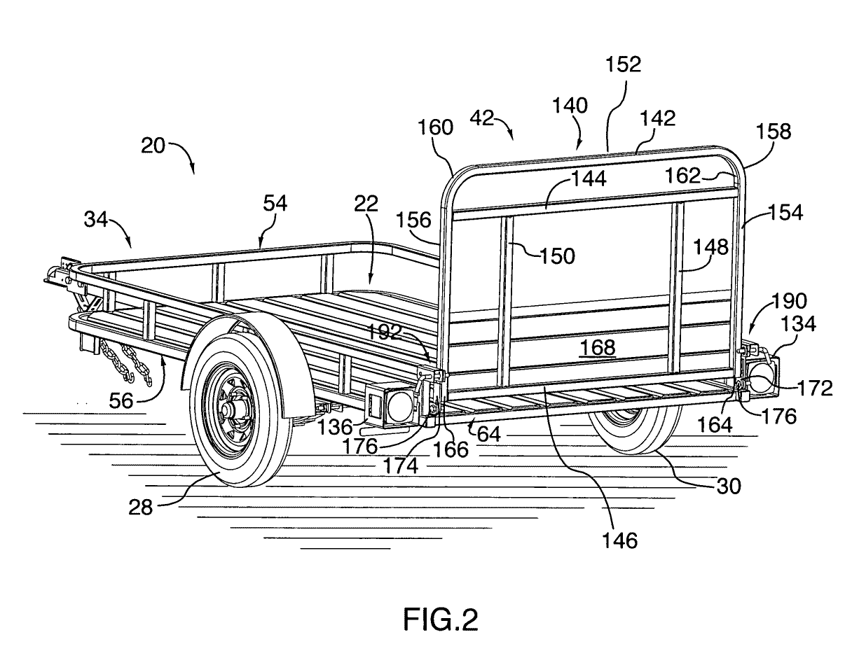

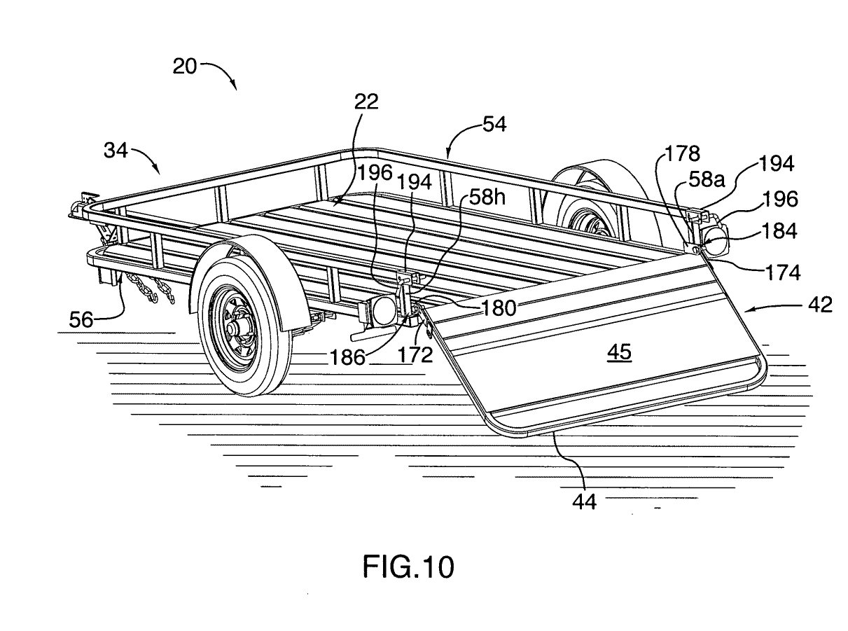

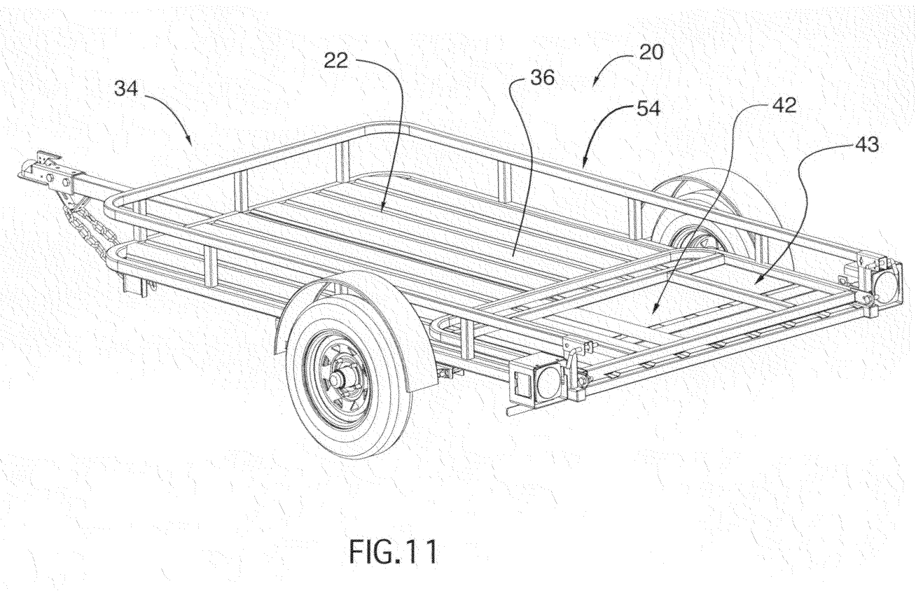

A gate 42 is pivotally connected to the support frame 34 at the rear end 52 thereof. The gate 42 is movable between a first lowered (out-of-use) storage position 43 (shown in FIG. 11) and a second declined (in-use) position 44 (shown in FIG. 10). When in the first lowered storage position 43, the gate 42 lies flat against the floor 36 trailer bed 22 and allows cargo (for example, lumber or the like) loaded onto the trailer bed 22 to extend beyond the support frame 34. When in the second declined position 44, the gate 42 forms a ramp 45 which permits access to the trailer bed 22 and facilitates loading. The gate 42 may also be moved to a third raised position 47 (shown in FIG. 2) substantially intermediate the first and second positions 43 and 44. When the gate 42 is in the raised position 46, the gate 42 is in a substantially upright position relative to the floor 36 of the trailer bed 22 and access to the trailer bed 22 is restricted. As described in greater detail below, locking means 48 are provided for maintaining the gate 42 in the raised position 46.

Referring to FIGS. 5, 6, 7 and 8, the support frame 34 includes: front and rear ends 50 and 52, a pair of spaced apart, upper and lower, generally U-shaped, bent structural members or rails 54 and 56 extending between the front and rear ends 50 and 52; a plurality of relatively short, post members or substantially upright struts 58a, 58b, 58c, 58d, 58e, 58f, 58g, 58h, 58i, 58j and 58k (collectively identified with reference numeral 58) extending between, and joining the U-shaped bent members 54 and 56 to each other; and first, second and third cross-members 60, 62 and 64 connected to the lower, U-shaped bent member 56.

Both U-shaped member 54, 56 are fabricated from sections of generally square hollow structural steel (HSS). In this embodiment, the initial length of member 54 prior to bending is 186 in., whereas the initial length of member 56 prior to bending is slightly greater, at 186.75 in. The cross-section of upper U-shaped member 54 is 1.25 in.×1.25 in. The lower U-shaped member 56 has a cross-section measuring 1.5 in.×1.5 in. The wall thickness of both members 54 and 56 is 0.065 in.

In other embodiments, longer or shorter sections could be employed. Similarly, in alternate embodiments the cross-section of the upper and lower U-shaped members could be increased or decreased to suit a particular application (and support a particular payload). While in this embodiment, the U-shaped members have a square cross-section, this need not be the case in every application. In an alternate embodiment, U-shaped members having rectangular cross-sections could be employed to similar advantage.

As will be explained in greater detail below, the use of U-shaped members having flat faces or sides tends to impart structural strength to the U-shaped members 54 and 56 and tends to provide suitable connection sites for welding the struts 58 to U-shaped members 54 and 56, thereby facilitating manufacture of the utility trailer 20.

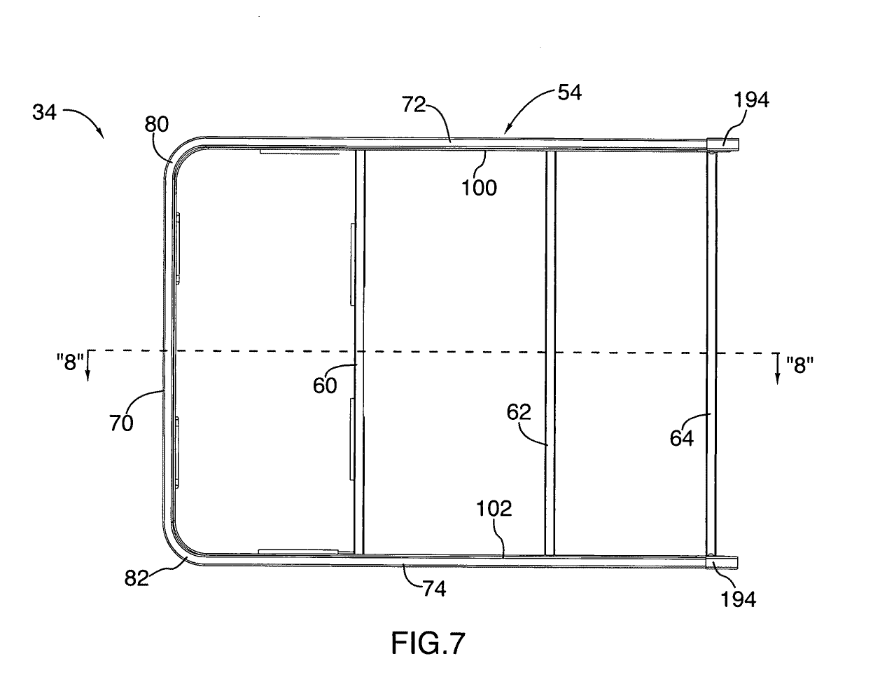

During fabrication, each member 54, 56 is bent inwardly at two locations to define its U-shape profile. The bending operation may be carried out by a hydraulic bender or other suitable device. Each member 54, 56 includes a back portion 70 and two opposed, generally parallel, first and second arm portions 72 and 74, each joined to the back portion 70. As best shown in FIG. 7, the back portion 70 is disposed at the front end of the support frame 34 intermediate the first and second arm portions 72 and 74. Each member 54, 56 is bent to form a first radiused corner portion 80 whereat the back portion 70 transitions to become the first arm portion 72, and a second radiused corner portion 82 whereat the back portion 70 transitions to become the second arm portion 74. The arm portions 72 and 74 extend generally perpendicularly away from the back portion 70 toward the rear end 52 of the support frame 34.

The formation of radiused corner portions 80 and 82 by bending the members 54 and 56 obviates the need to have welded connections or joints at the corners of the support frame 34. This tends to increase the structural strength of the support frame and its resistance to twisting, and further tends to minimize the risks of structural failures at the corners. In addition, support frames built in this fashion tend to be easier and cheaper to manufacture than conventional utility trailers because of reduced labour required during fabrication.

Each strut 58 is fabricated from a relatively short section of square hollow structural steel. In this embodiment, each strut 58 measures 5.25 in. in length and 1.25 in.×1.25 in cross-section. The wall thickness of each strut 58 is 0.065 in. In other embodiment, the struts could have a different length or have a rectangular cross-section.

Each of the struts 58 is welded to the lower face 84 of the upper U-shaped member 54 and the upper face 86 of the lower U-shaped member 56. Because the edges of the struts 58 and each of the upper face 86 and the lower face 84 have planar edges, the welds between the struts 58 and the U-shaped members tend to be easier to form and tends to be less prone to failure. It will thus be appreciated that this arrangement tends to offer real advantages over the use of tubular hollow structural steel sections having circular cross-sections, which require the ends of the struts to have arcuate notches corresponding to the curvature in the tubular structural steel sections making, thereby welding operation more complicated and more prone to failure.

Four struts—struts 58a, 58b, 58c and 58d—join the first arm portion 72 of the upper U-shaped member 54 to the first arm portion 72 of the lower U-shaped member 56. Strut 58a is located proximate the terminal or free end 88 of each first arm portion 72, whereas strut 58d is disposed at the opposite proximal end 90 of each first arm portion 72 adjacent the first radiused corner portion 80. Struts 58b and 58c are positioned intermediate struts 58a and 58b, with strut 58b being closer to strut 58a than to strut 58d, and strut 58c being closer to strut 58d than to strut 58a.

A similar arrangement of struts 58 exists on the opposite side of the support frame 34. Struts 58e, 58f, 58g and 58h—join the second arm portions 74 of the U-shaped members 54 and 56 to each other. The strut 58e is located proximate the terminal or free end 92 of the second arm portions 74, whereas the strut 58h is disposed near the opposite proximal end 94 of the second arm portions 74 adjacent the second radiused corner portion 82. Struts 58f and 58g are positioned intermediate struts 58e and 58h, with strut 58f being closer to strut 58e than to strut 58h, and strut 58g being closer to strut 58h than to strut 58e.

Struts 58i, 58j and 58k connect the back portions 70 of the U-shaped member 54 and 56 to each other. Strut 58i is disposed near first end 96 of the back portions 70 adjacent the first radiused corner portion 80 and strut 58k is located near the opposite end 98 thereof adjacent the second radiused corner portion 82. Strut 58j is positioned roughly midway between the struts 58i and 58k.

While in this embodiment, the support frame 34 includes eleven struts, in an alternative embodiment a greater or lesser number of struts laid out in an alternate arrangement to that described above, could be employed.

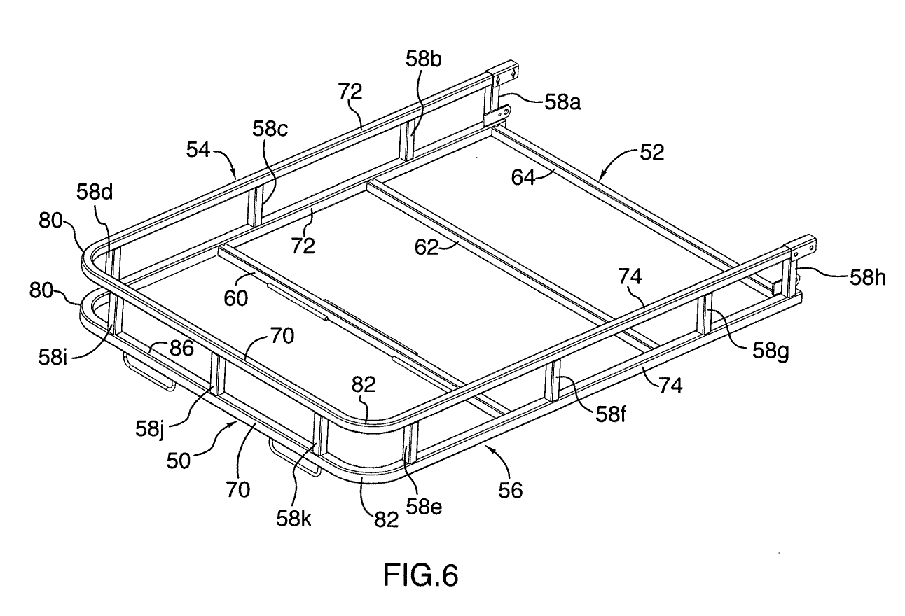

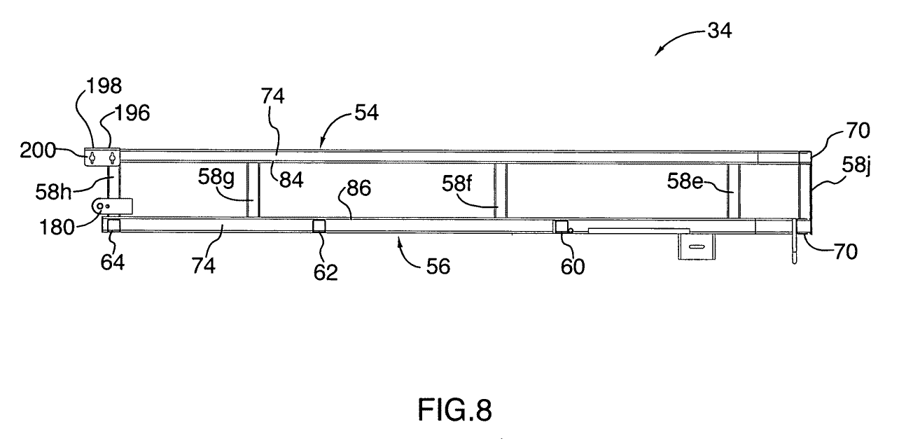

Referring to FIGS. 6 and 7, the first, second and third cross-members 60, 62 and 64 are disposed at spaced apart locations between the front and rear ends 50 and 52 of the support frame 34 and extend between and join the arm portions 72 and 74 of the lower U-shaped member 56. More specifically, each cross-member 60, 62 and 64 is fixed at one end to the inner lateral face 100 of arm portion 72 and secured at the opposite end to the inner lateral face 102 of arm portion 74. The first cross-member 60 is disposed closer to the front end 50 than to the rear end 52 and more specifically, between struts 58c and 58d on the one side, and struts 58e and 58f on the other side. The second cross-member 62 lies between struts 58b and 58e on the one side, and struts 58f and 58g on the other side. The third cross-member 64 is located at the rear end 52 of the support frame 34 on the same vertical plane as the struts 58a and 58h (as best shown in FIG. 8). The cross-members 60, 62 and 64 support the floor panels 38 and 40 that are mounted between the first and second arm portions 72 and 74 of the lower U-shaped member 56. In this embodiment, the cross-members 60, 62 and 64 are also square hollow structural steel (HSS) members measuring 1.25 in×1.25 in. in cross-section and having a wall thickness of 0.065 in. Each cross-member 60, 62 and 64 is 49.5 in. long.

As best shown in FIG. 5, a pair of spaced apart, first and second wire tubes 130 and 132 are mounted to extend beneath and transversely of the first and second cross-member 60 and 62. The first wire tube 130 is disposed adjacent and runs generally parallel to the first arm portion 72 of the lower U-shape member 56. Similarly, the second wire tube 132 lies near and runs generally parallel to the second arm portion 74 of the lower U-shape member 56. Each wire tube 130, 132 is intended to receive therethrough the electrical wires running from a signal light assembly 134, 136 (as the case may be) carried on either side of the support frame 34 at the rear end 52 thereof.

An elongate tongue 110 centrally disposed between the arm portions 72 and 74 of the lower U-shaped member 56, projects from the front end 50 of the support frame 34. The tongue 110 is secured to the support frame 34 by a pair of angle ties 112 and 114. The angle ties 112 and 114 extend between the back portion 70 of the lower U-shaped member 56 and the first cross-member 60. Each angle tie 112, 114 has a first leg 116 and a second leg 118 joined to the first leg 116 and extending perpendicularly thereof. In each case, one end of the first leg 116 is welded to the lower face 120 of the back portion 70, while the opposite end is welded to the lower face 122 of the first cross-member 60. The tongue 110 is mounted between the second legs 118 of angle ties 112 and 114 and retained in place by fasteners 116 inserted through the aligned apertures defined in the second legs 118 and the tongue 110. The tongue 110 carries at its free end 124 a coupler 126 for connecting the trailer 20 to the hitch (not shown) of a motor vehicle.

Referring to FIGS. 2, 9, 10 and 11, the structure and operation of the gate 42 is now described in greater detail. The gate 42 includes a frame 140 built up of several structural members—more specifically, an inverted U-shaped member 142; a pair of spaced apart, first and second cross-members 144 and 146; and a pair of longitudinal ties 148 and 150. The U-shaped member 142 is bent inwardly at two locations to define its U-shape profile. More specifically, the U-shaped member 142 includes a back portion 152 and two opposed, generally parallel, first and second arm portions 154 and 156, each joined to the back portion 152. The back portion 152 is disposed intermediate the first and second arm portions 154 and 156. The U-shaped member 142 is bent to form a first radiused corner portion 158 whereat the back portion 152 transitions to become the first arm portion 154, and a second radiused corner portion 160 whereat the back portion 152 transitions to become the second arm portion 156. The arm portions 154 and 156 extend generally perpendicularly away from the back portion 152.

The first cross-member 144 is carried between the first and second arm portions 154 and 156 adjacent the first and second radiused corner portions 158 and 160. One end of the first cross-member 144 is welded to the inner lateral face 162 of the first arm portion 154, while the opposite end is welded to the inner lateral face (not visible) of the second arm 156. Similarly, the second cross-member cross 146 extends between the first and second arm portions 154 and 156, but is disposed adjacent the terminal or free ends 164 and 166 of the arm portions 154 and 156. Joining the first cross-member 144 to the second cross-member 146 are the pair of spaced apart longitudinal ties 148 and 150. Longitudinal tie 148 extends generally parallel to, and is located proximate the first arm portion 154, while longitudinal tie 150 extends generally parallel to, and is located proximate the second arm portion 156.

The gate 42 further includes first and second, generally rectangular, back panels 168 and 170 extends which define the support surface for the ramp 45. The first back panel 168 extends from the terminal ends 164 and 166 toward the back portion 152 (only part way up the arm portions 154 and 156) and runs between the first and second arm portions 154 and 156. The first back panel 168 is secured to each of the second cross-member 146, the arm portions 154 and 156, and the ties 148 and 150 by welding. The second back panel 170 is mounted adjacent the first back panel 168 and extends from the margin of the first back panel 168 to terminate adjacent the first and second radiused corner portions 158 and 160. Each of the back panels 168 and 170 is secured to each of the first cross-member 146, the arm portions 154 and 156, and the ties 148 and 150 by welding. The second back panel 170 is welded to each of the first cross-member 144, the arm portions 154 and 156, and the ties 148 and 150. In this embodiment, each of the first and second back panels 168 and 170 are solid metal sheets. In other embodiments, the back panels could be expanded steel mesh.

Fixed to the outer lateral faces of each arm portion 154, 156 is a longitudinal plate 172, 174. The plates 172 and 174 extend beyond the terminal ends 164 and 166 of the arm portions 154 and 156. Each plate 172, 174 has an aperture (not visible) defined therein which is adapted to receive therein a hinge pin 176. The apertures in the plates 172 and 174 are alignable with corresponding apertures (not visible) defined in plates 178 and 180. The plate 178 extends transversely of, and is secured to, the strut 58a, while the plate 180 extends transversely of, and is fixed to, the strut 58h. The plates 172 and 178 and the hinge pin 176, on the one side, and the plates 174 and 180 and the hinge pin 176, on the other side, define the pair of hinges 184 and 186 which permit the gate 42 to pivot between the lowered position 44 and the raised position 46. A short distance away from each plate 172, 174, each arm portion 154, 156 has a transverse plate 182, 184, respectively, welded to its respective outer lateral face. Each transverse plate 182, 184 has an aperture (not visible). As explained in greater detail below, the transverse plates 182 and 184 partially define the locking means 48.

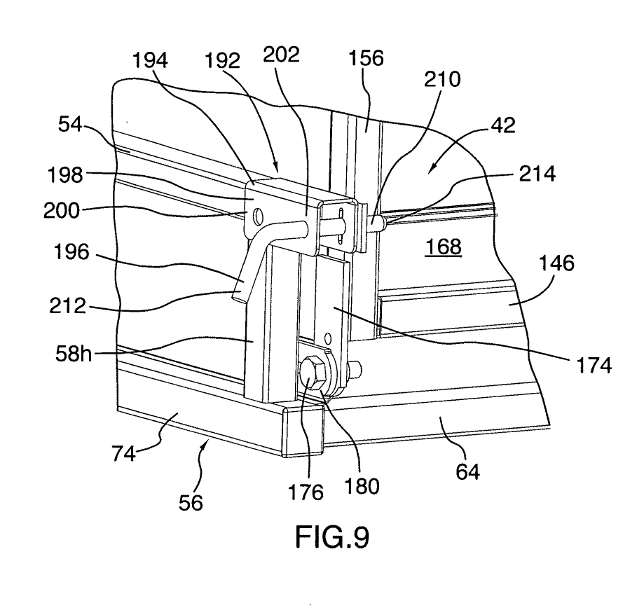

In the embodiment shown in FIGS. 2 and 9, the locking means 48 includes a pair of first and second locking assemblies 190 and 192. The first locking assembly 190 is operable to act on, or engage, the first arm portion 154. Similarly, the second locking assembly 192 is operable to act on, or engage, the second arm portion 156. The locking assemblies 190 and 192 are identical to each other in all material respects such that the description of one such locking assembly—the second locking assembly 192—will suffice for both. The locking assembly 192 includes a bracket 194 mounted to the upper U-shaped member 54, the transverse plate 180 fixed to the second arm portion 156 of the gate frame 140 (in the case of the first locking assembly 190, the transverse plate 178 fixed to the first arm portion 154) and a locking pin 196 engageable within the bracket 194 and the transverse plate 180 (in the case of the first locking assembly 190, the transverse plate 178). The bracket 194 takes the form of a generally C-shaped channel 198. The channel 198 is mounted to the second arm portion 74 of the upper U-shaped frame 54 and projects beyond the terminal end 92 thereof. The spaced apart legs 200 of the channel 198 are oriented downwardly and straddle the second arm portion 74 on either side. Adjacent its free end 202, the channel 198 has a pair of aligned apertures—each aperture defined in one leg 200. These apertures are sized to receive therethrough the locking pin 196.

In this embodiment, the locking pin 196 has a first relatively, straight portion 210 and a second dog-legged portion 212 joined to the first portion 210. The first straight portion 210 is adapted for insertion in the aligned apertures 204 defined in the legs 200 of the channel 198. The second dog-legged portion 212 defines a handle with which to grasp the locking pin 196.

To maintain the gate 42 in the raised position 46, the gate 42 is pivoted such that it stands upright of the trailer bed 22. Care is taken to align, on the one side, the aperture defined in the plate 180 with the apertures formed in the bracket 194 mounted to the second arm portion 74, and on other side, the aperture defined in the plate 178 with the apertures formed in the bracket 194 mounted to the first arm portion 72. Thereafter, the straight portion 210 of the locking pin 196 is inserted through the aligned apertures in the plate 180 and bracket 194, and in the plate 178 and opposite bracket 194. When the locking pins 196 are fully inserted, the terminal ends 214 of the straight portions 210 project beyond the plates 180 and 178. In order to move the gate 42 to the first lowered (out-of-use) storage position 43 or to the second declined (in-use) position 44, the locking pin 196 is disengaged from the plates 182 and 184 and the brackets 194 and the gate 42 is pivoted to the desired position.

From the foregoing, it will be appreciated that it is advantageous for a utility trailer to be provided with a support frame employing a dual, superimposed, bent U-shaped configuration with planar faces. Such a configuration tends to enhance the structural strength of the utility trailer and tends to offer improved resistance against bending or twisting. With the absence of welded connections at the corners, the support frame constructed in accordance with the principle of the present invention tend to be less prone to failure and more robust. As regards manufacturing, configured in this manner, the support frame (and the utility trailer) tend to require less welding. This tends, in turn, tends to lead to efficiencies in manufacturing resulting in reduced labour and costs.

Although the foregoing description and accompanying drawings relate to specific preferred embodiments of the present invention as presently contemplated by the inventor, it will be understood that various changes, modifications and adaptations, may be made without departing from the spirit of the invention.

What is claimed is:

1. A utility trailer comprising:
a trailer bed supported on wheels for rolling motion on the ground, the trailer bed including a floor on which cargo may be placed and a support frame for carrying the floor;
the support frame having:
a front end;
a rear end;
a pair of spaced apart, upper and lower, bent U-shaped members extending between the front and rear ends of the support frame; each U-shaped member being fabricated from a hollow section having one of a square cross-section and a rectangular cross-section;
a plurality of spaced apart, substantially upright struts extending between, and connecting the upper and lower bent U-shaped members to each other; and
a plurality of spaced apart cross-members connecting portions of the lower bent U-shaped member to each other; and
a gate pivotally mounted to rear end of the support frame, the gate being movable between a substantially upright position relative to the floor of the trailer bed and a lowered, in-use position.

2. The utility trailer of claim 1 wherein the floor is supported on the lower bent U-shaped member and the plurality of cross-members.

3. The utility trailer of claim 1 wherein at least one of the upper and lower bent U-shaped members has a square cross-section.

4. The utility trailer of claim 3 wherein both the upper and lower bent U-shaped members have a square cross-section.

5. The utility trailer of claim 1 wherein at least one of the bent U-shaped members has a rectangular cross-section.

6. The utility trailer of claim 5 wherein both the upper and lower bent U-shaped members have a rectangular cross-section.

7. The utility trailer of claim 6 wherein:
the upper bent U-shaped member has a first cross-sectional area;
the lower bent U-shaped member has a second cross-sectional area; and
the first cross-section area is smaller than or equal to the second cross-sectional area.

8. The utility trailer of claim 1 wherein:
each of the upper and lower bent U-shaped members includes a back portion and two opposed, generally parallel, first and second arm portions; the arm portions of each upper and lower bent U-shaped members being joined to the respective back portions of each upper and lower bent U-shaped members; and
each of the upper and lower bent U-shaped members being formed with a first radiused corner portion whereat the back portion of each upper and lower bent U-shaped members transitions to become the respective first arm portion of each upper and lower bent U-shaped members, and a second radiused corner portion whereat the back portion of each upper and lower bent U-shaped members transitions to become the respective second arm portion of each upper and lower bent U-shaped members.

9. The utility trailer of claim 8 wherein the portions connected by the plurality of cross-members are the first and second arm portions of the lower bent U-shaped member.

10. The utility trailer of claim 9 wherein the plurality of cross-members are disposed generally parallel to the back portion of the lower bent U-shaped member.

11. The utility trailer of claim 10 wherein:
each arm portion of the lower bent U-shaped member has an inner lateral, planar face; and
the first end of each cross-member is welded to the inner face of the first arm portion and the second end of each cross-member is welded to the inner face of the second arm portion.

12. The utility trailer of claim 10 wherein:
the first and second arm portions of the lower bent U-shaped member each include a proximal end connected to the back portion of the lower bent U-shaped member and a distal end;
the plurality of cross-members includes first, second and third cross-members;
the first cross-member is disposed adjacent the proximal ends of the first and second arm portions;
the second cross-member is disposed adjacent the distal ends of the first and second arm portions; and
the third cross-member is disposed intermediate the first and second cross-members.

13. The utility trailer of claim 1 wherein the plurality of cross-members have one of a square cross-section and a rectangular cross-section.

14. The utility trailer of claim 7 wherein:
the back portion and the first and second arm portions of the upper bent U-shaped member each have a lower planar face opposite the lower bent U-shaped member; and
the back portion and the first and second arm portions of the lower bent U-shaped member each have an upper planar face opposite the upper bent U-shaped member;
each strut of the plurality having an upper end and a lower end, the upper end of each strut being welded to the lower planar face of one the back portion and the first and second arm portions of the upper bent U-shaped member, the lower end of each strut being welded to the upper planar face of one the back portion and the first and second arm portions of the lower bent U-shaped member.

15. The utility trailer of claim 7 wherein the plurality of upright struts includes a first series of struts joining the first arm portion of the upper bent U-shaped member to the first arm portion of the lower bent U-shaped member, a second series of struts joining the back portion of the upper bent U-shaped member to the back portion of the lower bent U-shaped member and a third series of struts joining the second arm portion of the upper bent U-shaped member to the second arm portion of the lower bent U-shaped member.

16. The utility trailer of claim 15 wherein:
the first and second arm portions of each bent U-shaped member include a proximal end connected to the respective back portion of each bent U-shaped member and a distal end;
the first series of struts includes first, second, third and fourth struts;
the first strut is disposed adjacent the proximal ends of the first arm portions of the bent U-shaped members;
the second strut is disposed adjacent the terminal ends of the first arm portions of the bent U-shaped members; and
the third and fourth struts are disposed intermediate the first and second struts.

17. The utility trailer of claim 15 wherein:
the back portions of each bent U-shaped member include a first end joined to the respective first arm portion of each bent U-shaped member and a second end joined to the respective second arm portion of each bent U-shaped member;
the second series of struts includes first, second and third struts;
the first strut is disposed adjacent the first ends of the back portions of the bent U-shaped members;
the second strut is disposed adjacent the second ends of the back portions of the bent U-shaped members; and
the third strut is disposed intermediate the first and second struts.

18. The utility trailer of claim 15 wherein:
the first and second arm portions of each bent U-shaped member include a proximal end connected to the respective back portion of each bent U-shaped member and a distal end;
the third series of struts includes first, second, third and fourth struts;
the first strut is disposed adjacent the proximal ends of the second arm portions of the bent U-shaped members;
the second strut is disposed adjacent the terminal ends of the second arm portions of the bent U-shaped members; and
the third and fourth struts are disposed intermediate the first and second struts.

19. The utility trailer of claim 1 wherein the plurality of struts have one of a square cross-section and a rectangular cross-section.

20. The utility trailer of claim 1 further comprising at least one locking assembly engageable with the support frame and the gate for maintaining the gate in the substantially upright position.
